(19) United States
(12) Patent Application Publication
(10) Pub. No.: US 2004/0127242 A1
(43) Pub. Date: Jul. 1, 2004

(54) Apparatus and associated methods for the synchronization of shared content

(76) Inventors: Jane Y. Dashevsky, Beaverton, OR (US); Steve Dohrman, Hillsboro, OR (US); Carl Ellison, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/335,058

(22) Filed: Dec. 31, 2002

(51) Int. Cl. H04B 7/005; H04B 7/01; H04B 7/015; H04B 15/00

(52) U.S. Cl. 455/502

(57) ABSTRACT

An apparatus and associated methods for the synchronization of shared content are generally described.

### BRIEF DESCRIPTION OF THE DRAWINGS

Embodiments of the present invention are illustrated by way of example, and not by way of limitation, in the figures of the accompanying drawings in which like reference numerals refer to similar elements and in which:

FIG. 1 is a block diagram of an example operational environment incorporating the teachings of the present invention, according to one example embodiment;

FIG. 2 is a block diagram of an example synchronization agent architecture, in accordance with but one example embodiment of the invention;

FIG. 3 is a flow chart of an example method of synchronizing content within peers of a collaboration environment, according to one example embodiment of the present invention;

FIG. 4 is a flow chart of an example method of synchronizing content within peers of a collaboration environment, according to another example embodiment of the present invention;

FIG. 5 is a block diagram of an example data structure(s), suitable for use in accordance with one example embodiment of the present invention;

FIG. 6 is a block diagram of an example host collaboration appliance, according to one example embodiment of the present invention; and

FIG. 7 is a block diagram of an example article of manufacture including content which, when executed by an accessing appliance, causes the appliance to implement one or more aspects of an embodiment of the invention.

### DETAILED DESCRIPTION

Embodiments of the invention are generally directed to an apparatus and associated methods for the synchronization of shared content (objects) among endpoints with indeterminate availability. According to one example embodiment, a synchronization agent is introduced for implementation within, or association with, collaboration endpoints. As developed more fully below, a synchronization agent may establish and maintain synchronization of objects through analysis of the content within said objects, as well as the selective application of one or more synchronization rules. According to one example implementation, the synchronization rules applied may be differentiated based, for example, on object type, content type, object size, source, destination, and the like.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

Example Collaboration Environment

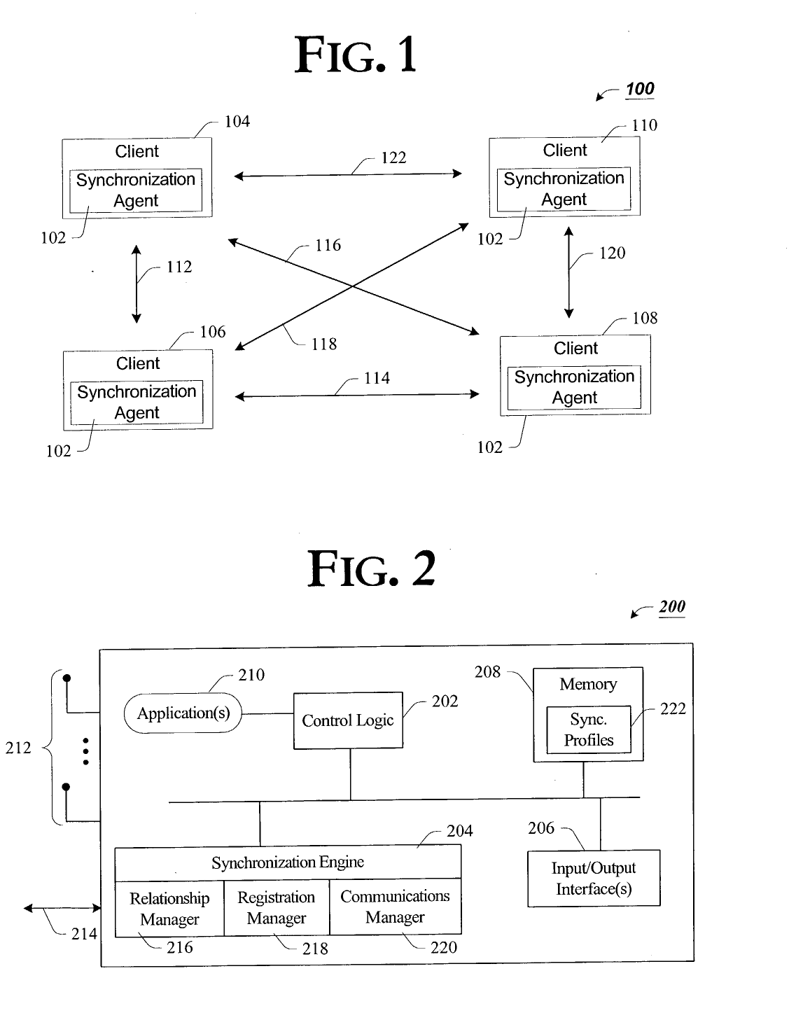

FIG. 1 illustrates a block diagram of an example operational environment 100 within which embodiments of the present invention may be practiced. In accordance with the illustrated example embodiment of FIG. 1, operational environment 100 is depicted comprising a number of client endpoints 10-110, at least a subset of which include an embodiment of synchronization agent 102 and which are, at least occasionally, but perhaps indeterminately, communicatively coupled through any of a number of communication media 112-122 as depicted, to facilitate communication between such endpoints. As introduced above, the introduction of an embodiment of synchronization agent 102 may enable such endpoints 104-110 to maintain synchronization of shared content among a defined group of other endpoints.

As used herein, but for their association with synchronization agent 102, client endpoints 104-110 are intended to represent any of a wide variety of electronic appliances that may be configured to communicate with other appliances using any of a number of wireless communication media (e.g., 112-122). In this regard, any one or more of endpoints 104-110 may well be any one or more of a computing appliance (e.g., laptop computer, desktop computer, palmtop computer, etc.), networking appliance, multimedia appliance (e.g., digital versatile disc (DVD) appliance, compact disc (CD) appliance, television, stereo, etc.), wireless communication appliance (e.g., cellular telephone, two-way radio, pager, etc.) and the like, or any combination thereof.

Similarly, communication media 112-122 are intended to represent any of a variety of wireless communication media including, but not limited to, wireless local area network (WLAN) communication channel(s), cellular telephony communication channel(s), two-way radio communication channel(s), paging channel(s), microwave channel(s), infrared communication channel(s), and the like, or any combination thereof. As illustrated by their unique reference numbers 112-122, each of communication media 112-122 may represent disparate ones of the variety of communication media. Thus, client 104 may well communicate with client 106 using one communication media 112, and (perhaps even simultaneously) communicate with client 110 with communication media 122 adhering to a different communication protocol than that of media 112.

As introduced above, synchronization agent 102 may establish and maintain the synchronization of shared content (synchronizable objects) between one or more endpoints 104-110 established as collaboration partners without the conventional need of a synchronized timebase, or a central management server. According to one embodiment, objects are established by a higher-level application (e.g., an electronic collaboration application). The application may well be provided by synchronization agent 102, or may be executing on a host electronic appliance. In either case, when an object is to be shared among other client endpoints 104-110, the object is registered with synchronization agent 102. According to one embodiment, during registration by synchronization agent 102, the object may be given a unique identifier to identify the object within a plurality of objects for each of any number of sessions (collaboration instances among at least a subset of a group), and groups managed by synchronization agent 102. As introduced above, objects may well be comprised of one or more other objects, which may also be uniquely identifiable within the host object.

To maintain the synchronization of registered objects, synchronization agent 102 may selectively exchange object replicas (e.g., their local representation of the object) with one another via wireless communication media 112-122. According to one embodiment, such exchange may be triggered by, e.g., a host application, a host client endpoint, at a predetermined time interval, upon receipt and successful update of a shared object, and the like.

A synchronization agent 102 may receive such object replicas (referred to as a remote object), compare the content against a local representation of the received object (referred to as a local object) and apply one or more synchronization rules to resolve what action to take in the event that a difference is identified between the content of the remote object and the local object. According to one example embodiment, synchronization agent 102 may selectively apply any one or more of a number of synchronization rules based, at least in part, on an object type, object size, object source, object destination, and the like.

According to one example implementation, upon completion of the analysis, synchronization agent 102 may update an object (i.e., the local object is updated with content from the remote object), whereupon synchronization agent 102 may provide an indication (referred to herein as a callback) to the higher-level application that an object has been updated. According to one embodiment, upon the successful update of an object, synchronization agent 102 may issue a message (e.g., a synchronization message) to one or more remote collaboration partners (e.g., defined by the higher-level application) with a replica of the newly updated object (which will be received as a “remote object” for use by receiving synchronization agents), as the process continues.

Thus, by utilizing at least a subset of the content within the shared object, and the selective application of one or more synchronization rules synchronization agent 102 may facilitate the synchronization of content in a fully distributed, heterogeneous ad-hoc network of indeterminately available endpoints 104-110.

Example Synchronization Agent

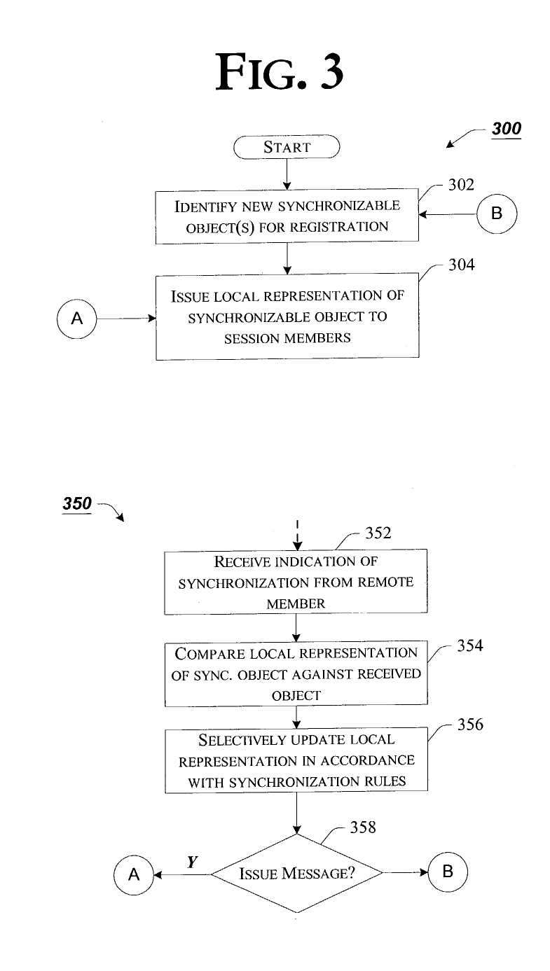

FIG. 2 illustrates a block diagram of an example synchronization agent architecture 200, according to one example embodiment of the invention. According to the illustrated example, synchronization agent 200 is depicted comprising one or more of control logic 202, a synchronization engine 204, one or more input/output (I/O) interface(s) 206, memory 208, application(s) 210, one or more antennas 212 and/or wired communication media 214. Although depicted as a number of disparate elements, those skilled in the art will appreciate that synchronization agents of greater or lesser complexity that nonetheless perform the functions of the claimed subject matter are anticipated within the scope and spirit of the present invention. According to one example implementation, embodiments of synchronization agent 200 may well be implemented as synchronization agent 104 in operational environment 100.

As used herein, control logic 202 may control the overall operation of synchronization agent 200. As discussed more fully below, control logic 202 may well interface with controllers, an operating system (OS), or application(s) (e.g., collaboration application(s)) of one or more host endpoints (e.g., 104) to invoke the features of synchronization engine 204. As used herein, control logic 202 is intended to represent any of a wide variety of control elements including, but not limited to, one or more of a microprocessor, a microcontroller, a field programmable gate array (FPGA), a digital signal processor (DSP), and/or software or firmware to implement one or more control functions generally attributed to control logic 202 herein. Indeed, any of the one or more elements of synchronization agent 200 may well be implemented in hardware, software, firmware or a combination thereof.

As introduced above, synchronization engine 204 is depicted comprising one or more of relationship manager 216, registration manager 218 and communications manager 220, which may be selectively invoked (by, e.g., control logic 202) to automatically establish and maintain the synchronization of objects among collaboration partners (endpoints). Although depicted as a number of disparate elements 216-220, those skilled in the art will appreciate that one or more of relationship manager 216, registration manager 218 and/or communication manager 220 may well be combined, or divided, to suit a given implementation requirement.

According to one embodiment, control logic 202 may receive an indication (e.g., a call) from a higher-level application (e.g., a collaboration application) denoting an object for which synchronization among collaboration partners is to be maintained. In response, control logic 202 may invoke an instance of registration manager 218 to register the object with synchronization agent 200. In this regard, registration manager 218 may assign an identifier to the object to uniquely identify the object within the number of objects associated with a collaboration group. For example, one object associated with each collaboration group is a list of participants maintained within a group object, to which registration manager 218 may assign an unique group identifier (group_ID). According to one embodiment, the group object main include identifiers associated with one or more of active group participants and/or removed group participants. According to one embodiment, separate objects are established for the active group participants (e.g., active group object) and removed group participants (e.g., removed group object), having their own unique identifier, and which may be maintained within the group object (e.g., denoted by group ID).

According to one embodiment, relationship manager 216 may be selectively invoked, e.g., by control logic 202, to manage and/or maintain the synchronization of registered objects. Thus, when synchronization agent 200 receives (e.g., via antenna 212) a replica of a registered object from a remote endpoint (i.e., a remote object), relationship manager 216 may be invoked (e.g., by control logic 202) to determine whether to update a local representation of the registered object (i.e., the local object).

According to one embodiment, relationship manager 216 may compare the content of the local object against the content of the remote object to identify differences there between. If differences are found, relationship manager 216 may apply one or more synchronization rules to determine how to proceed. According to one embodiment, the synchronization rules discussed herein may be maintained as an element of the synchronization profiles 222 in memory 208.

According to one embodiment, in one instance relationship manager 216 may determine that the local object is correct, whereupon communications manager 220 may be selectively invoked to issue a synchronization message to remote endpoints to update the source of the remote object. In another instance, relationship manager 216 may determine that the remote object is correct, whereupon relationship manager 216 may modify the local object to reflect the identified differences, before invoking an instance of communications manager 220 to inform a host application (if any) and/or remote endpoints of the updated object. In yet another instance, relationship manager 216 may determine that both a local and remote representations of an object need to be modified, whereupon relationship manager 216 updates a local representation and issues a message to remote endpoints including the updated local representation of the registered object.

According to one example embodiment, when the object under analysis is a participant list, relationship manager 216 may apply a synchronization rule from synchronization profiles wherein content removals from the object supersede content additions to the object. An example of relationship manager 216 operation in accordance with such a rule is provided in the following table:

TABLE I
Example Synchronization Functions

| | | |
|---|---|---|
| No. | Comparison | Actions |

| 1 | Local Object | No action is needed | |
|---|---|---|---|
| | (Lo) = Remote | | |
| | Object (Ro) | | |
| 2 | Lo = Ro + | Send sync update message to remote | |
| | Delta Remote | endpoint to add Delta | |
| 3 | Ro = Lo + | 1) | Update the local replica to add |
| | Delta Local | | Delta; |
| | | 2) | If syncing the list of participants, |
| | | | send the sync update message to |
| | | | remote endpoints that are being |
| | | | added to the local list |
| 4 | Ro + Delta | 1) | Send sync update message to |
| | Remote = | | remote endpoint; |
| | Lo + Delta | | |
| | Local | | |
| | | 2) | Update the local replica; |
| | | 3) | If syncing the list of participants, |
| | | | send the sync update message to |
| | | | remote participants added to the |
| | | | local list. |

Communications manager 220 may be utilized to generate messages to communicate with one or more of, e.g., host application(s) (e.g., via a callback message), or remote endpoints (e.g., via a synchronization message) through input/output (I/O) interface(s) 206. According to one embodiment, communications manager 220 may well include wireless communication resource(s) (e.g., a transmitter and receiver or transceiver), or may utilize such resources located in IO interface(s) 206, or those of a host electronic appliance. According to but one example embodiment, communications manager 220 may issue one or more callback message(s) to inform a host application (e.g., a collaboration application) regarding a change in synchronization status of a collaboration object.

According to one example embodiment, the callback messages may include one or more of: synchronization advised, synchronization complete, object added, and/or object removed, the definition of which is derived from the plain meaning of the language. In addition, communications manager 220 may issue a synchronization message in response to an update/modification to a registered object. According to one example embodiment, the synchronization message may include a replica of the updated/modified object which, when received by a remote synchronization agent 200, may be treated by the receiving synchronization agent 200 as a remote object for the purposes of the analysis described above.

As used herein, synchronization agent 200 may support collaboration between two or more endpoints, and that collaboration with any individual endpoint may be on an indeterminate (or, unscheduled) basis. To facilitate such collaboration, relationship manager 216 may maintain one or more of a list of all active collaboration partners (endpoints) and/or removed collaboration partners associated with one or more collaboration groups. According to one example embodiment, such list(s) may well be maintained within synchronization profile(s) 222 associated with the groups. According to one embodiment, whenever a change is made to a local representation of an object, and a (e.g., synchronization) message is issued to update remote endpoints, relationship manager 216 may track synchronization messages received from remote endpoints to ensure that an appropriate update (i.e., reflecting the changes to the local object) of the object is received from each member of the group. Until such a synchronization message is received from each endpoint within a group, synchronization agent 200 may periodically issue a (e.g., synchronization) message to such endpoint(s) until such a synchronization message is received. In this way, synchronization agent 200 supports synchronization of shared content among endpoints with indeterminate availability.

Input/output (IO) interface(s) 206 is intended to cover a wide variety of wired and wireless IO interfaces may enable one or more elements of synchronization agent 200 to communicate with other elements of, e.g., a host appliance (e.g., microprocessor), and/or remote appliances. According to one example embodiment, IO interface(s) 206 include the physical hardware and software features and protocols that enable synchronization agent 200 to communicate over wired 214 and/or wireless 212 communication hardware, in accordance with any of a number of communication protocols.

Similarly, memory 208 may represent any of a wide variety of volatile and/or non-volatile storage technologies, suitable for use by synchronization agent 200 to store one or more synchronization profile(s) 222. But for the storage of synchronization profiles 222 in support of embodiments of the present invention, memory 208 is intended to reflect any of a number of known memory storage technology and, as such, need not be described further herein. According to one example embodiment, synchronization profiles(s) 222 may include one or more synchronization rules selectively invoked by, e.g., relationship manager 216 based, at least in part, on one or more attributes of an object under analysis.

According to one example embodiment, application(s) 210 may represent any of a wide variety of content executable by, e.g., control logic 202 of synchronization agent 200 or of a host appliance, to implement one or more features described herein, e.g., graphical user interface, communication application(s), and the like. Application(s) 210 may include a collaboration application, through which users of endpoints 104-110 can establish, manage and participate in an electronic collaboration environment through communication media (e.g., 112-122). According to one example embodiment, collaboration application 210 selectively utilizes the services of synchronization engine 204 introduced above, and developed more fully below, to maintain the synchronization of objects associated with one or more collaboration groups established by the collaboration application 210. In this regard, according to one example implementation, synchronization agent 200 may represent a complete collaboration tool to enable host appliances to facilitate electronic collaboration with other, appropriately endowed appliances.

According to one example implementation, synchronization agent 200 may be an application program interface (API), an element of an operating system (OS), an element of an electronic collaboration application executing on a host electronic appliance; synchronization agent 200 may well be implemented in hardware, software, firmware, or a combination thereof.

Operational Example(s)

Having introduced an example operating environment and architectural elements of the synchronization agent 200, above, attention is now directed to FIG. 3 where an operational example implementation of the synchronization agent 200 is presented in greater detail. For ease of illustration, and not limitation, the method of FIG. 3 is developed with continued reference to FIGS. 1 and 2, as appropriate. Nonetheless, it is to be appreciated that the teachings of FIG. 3 may well be implemented in alternate network architectures/configurations without deviating from the spirit and scope of the present invention.

FIG. 3 is a flow chart of an example method of synchronizing shared content among peers of a collaboration environment, according to one example embodiment of the present invention. In accordance with the illustrated example embodiment, a method 300 begins with block 302 wherein synchronization agent 200 may receive a synchronizable object. As introduced above, the object may be received from a higher-level application (e.g., a collaboration application). According to one example embodiment, control logic 202 may invoke an instance of registration agent 218 to register the object for use by the synchronization agent 200.

In block 304, synchronization agent 200 may issue a message to remote endpoints to synchronize the newly registered object. According to one example implementation, introduced above, control logic 202 may invoke an instance of communications manager 220, which may generate a synchronization message for transmission to remote endpoints. According to one example embodiment, communications manager 220 may generate a synchronization message that includes a replica of the object, which is transmitted to remote endpoints via antenna(e) 212 and one or more communication media (e.g., 112-122).

The process continues with example method 350, which begins with block 352 wherein a synchronization agent 200 receives an indication of synchronization (e.g., a synchronization message) from a remote endpoint (collaboration partner). As introduced above, such indication is received via one or more communication media (e.g., 112-122) via antenna(e) 212 and IO interface(s) 206 at communication manager 220.

In block 354, synchronization agent 200 may compare a local representation of the object (local object) against the received representation of the object (remote object) to identify any differences in content there between. More particularly, upon receiving a synchronization message, control logic 202 may invoke an instance of relationship manager 216 to compare the local object against the remote object to identify differences in content between the representations of the object.

As introduced above, in accordance with one embodiment, if differences are identified relationship manager 216 may selectively update the local representation of the object in accordance with one or more synchronization rules, block 356. According to one embodiment, introduced above, relationship manager 216 may access one or more synchronization profiles 222 to identify one or more synchronization rules to apply in resolving the differences between the objects. An example of one such set of rules is provided in Table I, above.

In block 358, synchronization agent 200 may determine whether to issue a message updating one or more of a host application (e.g., collaboration application), a remote endpoint(s), and the like. As introduced above, whether an update message is issued by communications manager 220 may well depend on what action is taken by relationship manager 216 in block 356. For example, if the local representation of the object is updated, a callback may be issued to so inform a host application. Similarly, a synchronization message may be generated and issued to inform other collaboration partners of the change in content. An example of actions taken in response to actions taken by relationship manager 216 is presented in Table I, above.

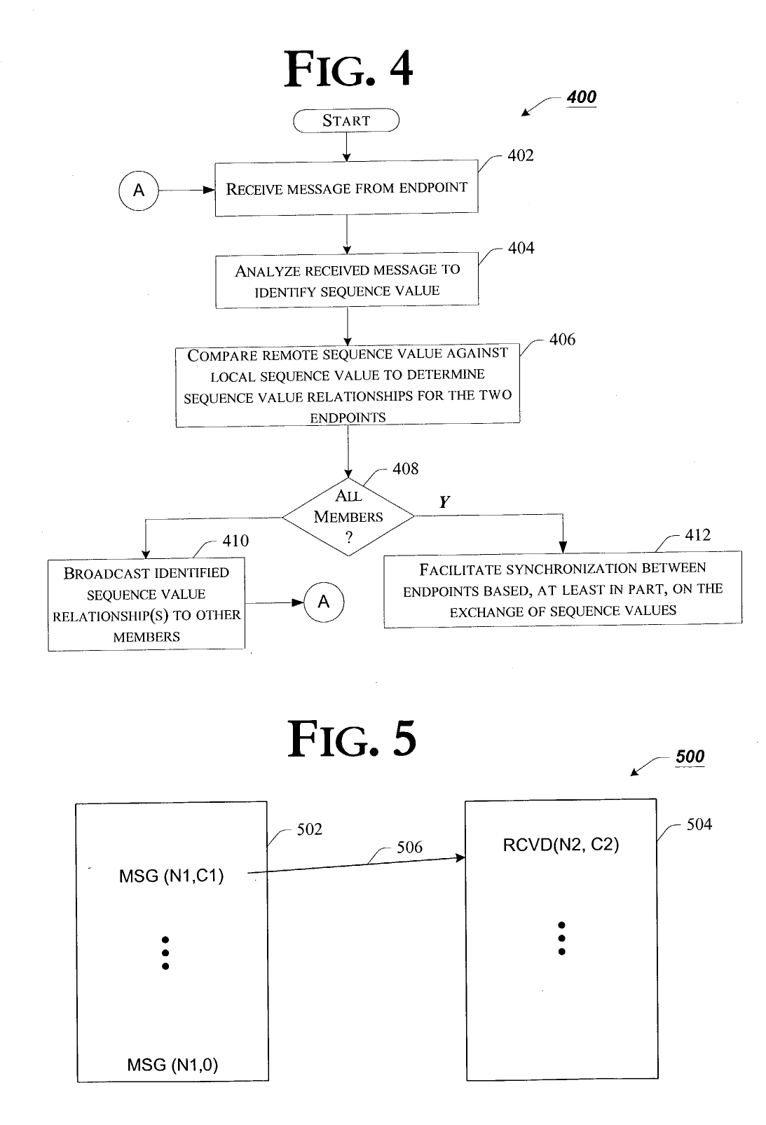

FIG. 4 is a flow chart of an example method of synchronizing content among collaboration partners, according to another example embodiment of the present invention. In accordance with the illustrated example embodiment of FIG. 4, the method begins with block 402 wherein synchronization agent 200 receives a message (e.g., a synchronization message) from a remote endpoint.

In block 404, synchronization agent 200 analyzes at least a subset of the received message to identify a source identifier (e.g., a node_ID), and a sequence value associated with the remote (source) endpoint. According to one example embodiment, the sequence value within an endpoint is associated, or otherwise denotes the number of changes that have occurred within a shared object at that node. That is, synchronization agent 200 in each endpoint increments a local sequence counter for each change made to an object within a collaboration group.

In block 406, synchronization agent 200 compares the sequence value derived from the received message (referred to as the remote sequence value) against a locally maintained sequence value. More specifically, according to one embodiment, synchronization agent 200 compares the remote sequence value and at least a subset of the remote object against a local sequence value and local object to determine a relationship between the remote sequence value and the local sequence value. In this regard, over a period of time, synchronization agent 200 may establish a paradigm of time based on a combination of node identifier and sequence value. That is, based on the comparison described above, synchronization agent 200 can determine whether the local sequence value represents a point in time before or after a point in time represented by the remote sequence value, enabling synchronization agent 200 to determine whether a remote object is more or less current than the local object. Once established, synchronization may occur based, at least in part, through analysis of the respective sequence values associated with a received (synchronization) message associated from a given endpoint.

In block 408, a determination is made whether sequence value relationships have been established with all members of the collaboration group. If so, collaboration may continue wherein synchronization agent 200 maintains synchronization of shared content through the use of such sequence values, block 412.

Alternatively, in block 410, synchronization agent 200 broadcasts the identified sequence value relationship to synchronization agents 200 associated with other collaboration endpoints, which may use such information in establishing the relationship between a local sequence value and those of the two endpoints just synchronized.

FIG. 5 is a graphical illustration of example data structure(s), suitable for use in accordance with one example embodiment of the present invention. In accordance with the illustrated example implementation of FIG. 5, two data structures 502, 504 are depicted associated with two collaboration partners (e.g., 104, 106). As shown, over time messages are exchanged between the two endpoints and data structures 502, 504 maintain a buffer of such messages. In accordance with the illustrated example method of FIG. 4, such messages include an indication of a message count maintained at the sender between such endpoints. At some point, a the synchronization agent 200 in the receiving endpoint may be able to determine a relationship between the counter maintained at the sender, and provided in each message, e.g., message 506, and a local counter. Based on this relationship, the synchronization agent 200 in the receiving endpoint may determine a relative order to communications between the two endpoints. According to one embodiment, synchronization agent 200 may transmit this information to synchronization agents 200 in other endpoints participating in a collaboration. Over time, as individual synchronization agents 200 identify a relationship between their disparate counters, a paradigm of time is established which may be used to synchronize content, in accordance with the method of FIG. 4, above.

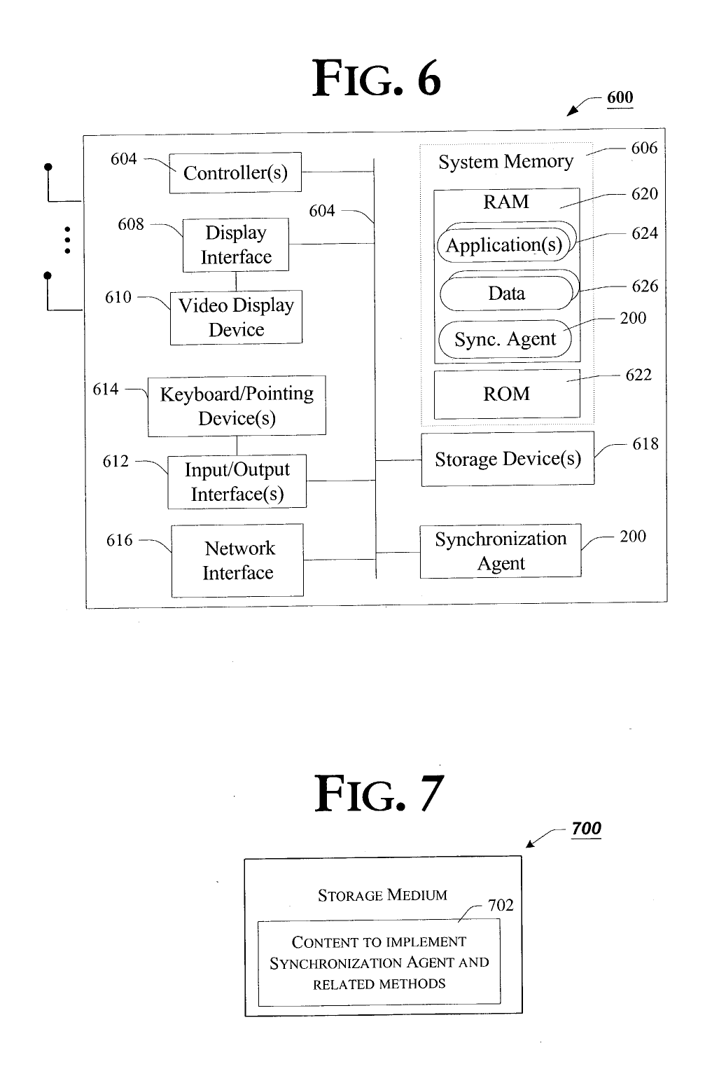

FIG. 6 is a block diagram of an example electronic appliance 700 suitable for use in accordance with one example embodiment of the present invention. In accordance with the illustrated example embodiment of FIG. 6, electronic appliance 600 is depicted comprising one or more of controller(s) 602, system memory 606, a display interface 608 and associated display device 610, one or more input/output interface(s) 612 and associated peripheral (e.g., keyboard and/or pointing) devices 614, network interface(s) 616, storage device(s) 618 and, in alternate embodiments, synchronization agent 200 incorporating the teachings of the present invention, each coupled as depicted. As shown, system memory may include random access memory (RAM) 620 and read-only memory (ROM) 622. RAM 620 is depicted comprising applications 624 including, in accordance with one embodiment, an application to implement the synchronization agent 200 presented above, and data 626. In this regard, synchronization agent 200 may well be implemented in hardware, software, firmware or a combination thereof.

As used herein, but for the introduction of synchronization agent 200 and the capability associated therewith, electronic appliance 600 is intended to represent any of a wide variety of electronic appliances know in the art including, but not limited to computing devices, communication devices, home appliances, multimedia appliances, networking appliances, and the like. In this regard, electronic appliances 600 of greater or lesser complexity that nonetheless incorporate the teachings associated with synchronization agent 200 are anticipated within the spirit and scope of the present invention.

Alternate Embodiment(s)

FIG. 7 illustrates a block diagram of an example storage medium comprising a plurality of executable instructions which, when executed, may cause an accessing machine to implement one or more aspects of the synchronization agent architecture 200 and/or associated methods 300, 400. In this regard, storage medium 700 includes content 702 which, when executed, causes an accessing appliance to implement one or more aspects of synchronization agent 200, described above.

The machine-readable medium 700 may include, but is not limited to, floppy diskettes, optical disks, CD-ROMs, and magneto-optical disks, ROMs, RAMs, EPROMs, EEPROMs, magnet or optical cards, flash memory, or other type of media /machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various operations. The operations of the present invention may be performed by hardware components, such as those shown in FIGS. 1, 2 and/or 6, or may be embodied in machine-executable content (e.g., instructions) 702, which may be used to cause a general-purpose or special-purpose processor or logic circuits programmed with the instructions to perform the operations. Alternatively, the operations may be performed by a combination of hardware and software. Moreover, although the invention has been described in the context of a computing appliance, those skilled in the art will appreciate that such functionality may well be embodied in any of number of alternate embodiments such as, for example, integrated within a communication appliance (e.g., a cellular telephone).

Many of the methods are described in their most basic form but operations can be added to or deleted from any of the methods and information can be added or subtracted from any of the described messages without departing from the basic scope of the present invention. Any number of variations of the inventive concept are anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

What is claimed is:

1. An apparatus comprising:
a wireless communication resource, coupled with one or more antenna(e), to enable wireless communication with a remote apparatus; and
a synchronization agent, coupled with the wireless communication resource, to receive one or more collaboration objects from the remote apparatus, and selectively synchronize a local representation of the received object(s) based, at least in part, on the content of the received objects.

2. An apparatus according to claim 1, wherein the wireless communication resource is a wireless receiver, suitable for use with one or more of a wireless local area network (WLAN), wireless communications network, or an infrared (IR) communication channel.

3. An apparatus according to claim 1, wherein synchronization agent issues a synchronization message with an updated local representation of the received object(s) to one or more remote apparatuses.

4. An apparatus according to claim 1, wherein synchronization agent compares the received object against the local object to identify differences in content between the two objects, and determines whether the local or received object requires synchronization based, at least in part, on one or more synchronization rules, or other locally maintained content.

5. An apparatus according to claim 4, wherein the synchronization rules or other locally maintained content includes one or more of a list of active collaboration members, and a list of removed collaboration members.

6. An apparatus according to claim 1, wherein synchronization agent compares a sequence value associated with a sender of the received object against a local sequence value to identify a sequence value relationship between the two apparatuses.

7. An apparatus according to claim 6, wherein synchronization agent determines whether to synchronize a local representation of a received object with the received object based, at least in part, on the sequence value relationship between the two apparatuses.

8. A method comprising:
receiving a collaboration object from a remote apparatus; and
selectively synchronizing a local representation of the received object to the received object based, at least in part, on the content of the received objects.

9. A method according to claim 8, wherein selectively synchronizing comprises:
comparing a source of the received collaboration object against one or more of a list of active collaboration partners or a list of removed collaboration partners; and
disregarding the received object if it is received from a source identified from the list of removed collaboration partners.

10. A method according to claim 9, further comprising:
comparing at least a subset of content of the received object against a local representation of the received object to identify differences between such objects; and
updating the local representation of the received object to reflect the received object based, at least in part, on locally maintained synchronization rules.

11. A method according to claim 10, the synchronization rules including a rule that removed content has higher precedence than added content, wherein conflicts are resolved in favor of removing content from an object.

12. A method according to claim 8, wherein selectively synchronizing comprises:
identifying a sequence value associated with a source of the received object in communication including the received object;
comparing the sequence value against a local sequence value to identify a sequence value s relationship between the source apparatus and a host apparatus.

13. A method according to claim 12, further comprising:
determining whether to synchronize a local representation of the received object to the received object based, at least in part, on the identified sequence value relationship.

14. A storage medium comprising content which, when executed by an accessing electronic appliance, causes the appliance to implement a method including,
receiving a collaboration object from a remote apparatus; and
selectively synchronizing a local representation of the received object to the received object based, at least in part, on the content of the received objects.

15. A storage medium according to claim 14, wherein the content to implement the method further comprising:
comparing a source of the received collaboration object against one or more of a list of active collaboration partners or a list of removed collaboration partners; and
disregarding the received object if it is received from a source identified from the list of removed collaboration partners.

16. A storage medium according to claim 15, wherein the content to implement the method further comprising:
comparing at least a subset of content of the received object against a local representation of the received object to identify differences between such objects; and
updating the local representation of the received object to reflect the received object based, at least in part, on locally maintained synchronization rules.

17. A storage medium according to claim 16, wherein the content to implement the method further comprising content to implement one or more synchronization rules including, in part, a rule that removed content has higher precedence than added content, wherein conflicts are resolved in favor of removing content from an object.

18. A storage medium according to claim 14, wherein the content to implement the selective synchronization comprises:
identifying a sequence value associated with a source of the received object in communication including the received object;
comparing the sequence value against a local sequence value to identify a sequence value relationship between the source apparatus and a host apparatus.

19. A storage medium according to claim 18, wherein the content to implement the method further comprising:
determining whether to synchronize a local representation of the received object to the received object based, at least in part, on the identified sequence value relationship.

20. A system comprising:
a wireless communication network; and
one or more collaboration endpoints, indeterminately coupled through the wireless communication network, at least a subset of which including a synchronization agent to receive collaboration objects from remote endpoints and selectively update a local representation of such objects based on the content of the object and synchronization rules.

21. A system according to claim 20, wherein the wireless communication system is one or more of a wireless local area network (WLAN), wireless communication system, or an infrared (IR) communication channel.

22. A system according to claim 20, wherein the synchronization agent maintains a list of active endpoints, and includes a rule that content removal from an object takes precedence over content addition within the object, such that conflicts are resolved in favor of removal.
